(19) United States
(12) Patent Application Publication
(10) Pub. No.: US 2007/0011602 A1
(43) Pub. Date: Jan. 11, 2007

(54) System and method for securely transmitting data to a multimedia device

(75) Inventors: Atul M. Anandpura, San Diego, CA (US); David S. Baggest, Murrieta, CA (US); Kevin A. Bostenero, Poway, CA (US)

Correspondence Address: THORPE NORTH & WESTERN, LLP., 8180 SOUTH 700 EAST, SUITE 200, SANDY, UT, 84070, US

(73) Assignee: e.Digital Corporation, San Diego, CA (US)

(21) Appl. No.: 11/522,000

(22) Filed: Sep. 14, 2006

Related U.S. Application Data
(62) Division of application No. 10/938,060, filed on Sep. 9, 2004.

(51) Int. Cl. G06F 17/00; G06F 15/00

(52) U.S. Cl. 715/500.1

(57) ABSTRACT

A system and method is disclosed for securely storing and performing digital media files in a multimedia device. The method can include the operation of storing one or more digital media files on a digital storage medium in a predetermined file format. The digital storage medium can located within the multimedia device. Data comprising predetermined file format information and the digital media can be secured on the digital storage medium without securing commands necessary to store the digital media on the digital storage medium. The multimedia device can be connected to an external source to authenticate the multimedia device. The digital media can be processed to a media form that will allow the digital media to be performed. A real time clock operatively connected to the multimedia device can be used to determine the length of time that a digital media file is stored on the digital storage medium.

This application is a divisional application of copending U.S. patent application Ser. No. 10/938,060, filed Sep. 9, 2004, which is hereby incorporated herein by reference in its entirety.

### FIELD OF THE INVENTION

The present invention relates generally to the secure distribution of digital media for entertainment purposes.

### BACKGROUND

Digital multimedia is quickly becoming the standard format for audiovisual entertainment. Movies, music, video games, and even pictures can quickly and economically be distributed in a digital format to consumers. The revolution to a digital format brought with it innumerable opportunities for new devices and methods for viewing multimedia. Consumers can now store their music on optical disks, solid state memory to be used in computers and MP3 players, hard drives in computers and multimedia systems, and other digital formats, allowing them to conveniently listen to their music. Music, pictures, and even movies can be easily shared on the internet. These new abilities also allow consumers the freedom to easily find and arrange their favorite songs in the order they desire, and even store thousands of songs, often their entire collection, on a single portable device.

Previously, format changes have been a boon to the entertainment industry. Each time the standard format changed from vinyl record to eight-track to cassette tape to CD, and from VHS to DVD, consumers have re-purchased many of their old albums in the new format. The entertainment industry anticipated that the current digital revolution, offering vast freedoms and abilities to alter, reorganize, and transmit digital information such as music and video, would provide a new wave of sales as consumers purchased music and movies available in all the new formats. In contrast to previous format changes, however, the digital revolution has actually become a great hindrance to the music industry. Rather than purchasing new music, or repurchasing old music in the new format, consumers are now using the digital revolution to trade the music for free on the internet, and then copy it to their computer, their CD players, and their MP3 players. Distributing movies in a like manner is limited only by bandwidth, which is rapidly increasing. For the first time, consumers can obtain music and movies without the distribution system set up by the media industry.

Enforcing copyright laws on individual citizens trading music in the comfort of their own homes has proven quite difficult. The damage caused to the music industry by illegal copying and trading has forced other multimedia industries to take note. The movie industry in particular could be greatly damaged if movies become as widely traded as music currently is. Big budget movies can cost over one hundred million dollars to make. Without a vast number of consumers paying to view and purchase the movies, the industry would soon come to a halt.

Due to pressures from the movie industry, the digital revolution has been largely absent in areas other than music. Despite the possible benefits from new digital hardware and software to view movies, the movie industry fears letting the proverbial cat out of the bag. The pressure has limited the possibilities of downloading movies at home, or allowing them to be transferred between digital devices. The movie industry often doesn't allow its movies to even be distributed in a digital format before the release to video, fearing that people won't pay to see movies at the theater if they already have them at home.

### SUMMARY OF THE INVENTION

A system and method is disclosed for securely storing and performing digital media files in a multimedia device. The method can include the operation of storing one or more digital media files on a digital storage medium in a predetermined file format. The digital storage medium can located within the multimedia device. Data comprising predetermined file format information and the digital media can be secured on the digital storage medium without securing commands necessary to store the digital media on the digital storage medium. The multimedia device can be connected to an external source to authenticate the multimedia device. The digital media can be processed to a media form that will allow the digital media to be performed. A real time clock operatively connected to the multimedia device can be used to determine the length of time that a digital media file is stored on the digital storage medium.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram illustrating a system for securely distributing digital media files in accordance with an embodiment of the present invention; and

FIG. 2 is a block diagram depicting a method for securely storing and performing digital media files in a multimedia device in accordance with an embodiment of the present invention.

### DETAILED DESCRIPTION

Reference will now be made to the exemplary embodiments illustrated in the drawings and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one, skilled in the relevant art and having possession of this disclosure, are to be considered within the scope of the invention.

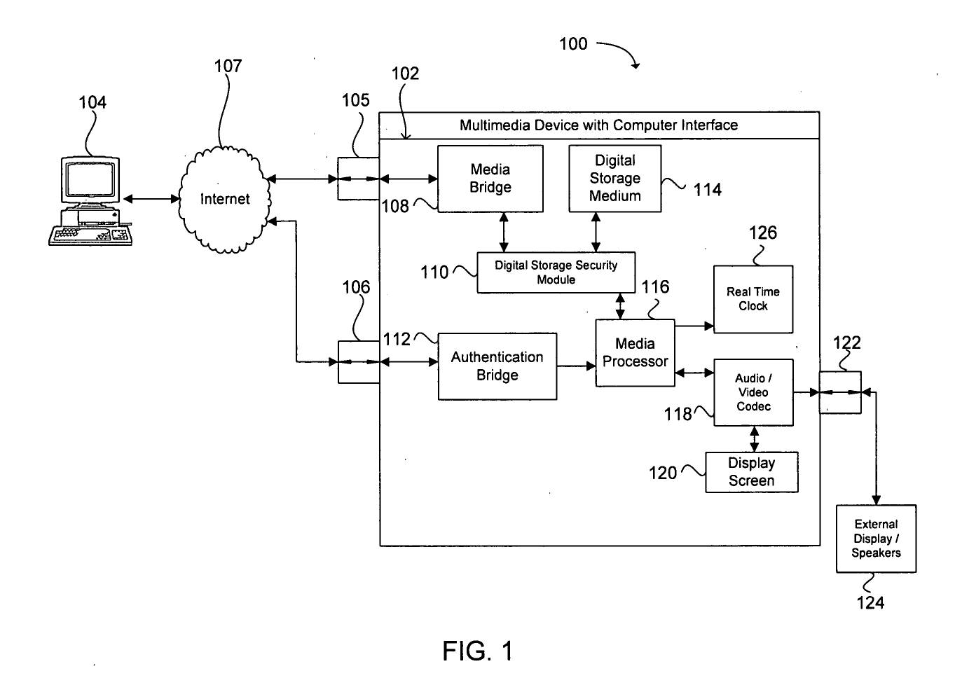

In order to overcome the problems described and to provide a secure system for distributing, storing, and performing digital media files, the present invention provides a system and method for securely storing and performing digital media files in a multimedia device, as illustrated in FIG. 1. The secure multimedia distribution system 100 includes a multimedia device 102. The multimedia device comprises a media processor 116 and a digital storage medium 114. The media processor can be a digital signal processor, a central processing unit such as an Intel X86 chip, an IBM PowerPC chip, or an equivalent processor. Alternatively, the media processor can be a microcontroller or a reconfigurable Field Programmable Gate Array (FPGA) computer chip such as a Xilinx programmable logic device. The digital storage medium can comprise a hard drive, an optical storage device such as a CD or DVD, a solid state memory such as random access memory (RAM), magnetic RAM, Flash RAM, or a combination of these devices. For example, the digital storage medium can comprise a hard drive and a receptacle for a solid state memory card. The digital storage medium may comprise any other means not listed which can be used for storing large amounts of digital data.

A media port 105 can be configured to connect the digital storage medium 114 to a media source external to the multimedia device 102. The media source can be a personal computer 104. The personal computer can be connected to the internet 107. Alternatively, the multimedia device can be connected directly to the internet, wherein the internet can be used directly as a media source. The media source may also be an external digital memory device. Multimedia, including music, movies, video games, and software such as scheduling software can be transmitted from the media source to the multimedia device. The multimedia device can be connected to the media source through a high-speed connection such as a Universal Serial Bus, Firewire bus (IEEE 1394), Ethernet connection, parallel connection, serial connection, PCMCIA port, or other connection through which large amounts of data can be sent.

In another embodiment, digital media files from the media source can be transmitted wirelessly to the multimedia device. A wireless format such as the IEEE 802.11 wi-fi specification can be used. Other wireless formats such as Bluetooth, Zigbee, or Ultrawideband, as described in the IEEE 802.15 specification, can also be used to wirelessly transmit digital media files to the multimedia device. The wireless format can include encryption to enable the transmission to be secure such that the digital media files cannot be easily intercepted by unintended users.

An integrated circuit (IC) or application specific integrated circuit (ASIC) can be configured as a media bridge 108 between the digital storage medium 114 and the media source through the media port. Media bridge ICs are commonly available off-the-shelf from suppliers. The media bridge can be used to transfer and translate digital data from the media source to the digital storage medium in a format that is acceptable for storing in the digital storage medium.

The media bridge 108 can make it uncomplicated to transfer digital media files to and from the digital storage medium 114. Easy access can be an advantage to the consumer, but it can also allow for proliferation of the digital media content from the consumer to the public. In order to protect the media content provider, the multimedia distribution system can ensure that the digital media files are protected from copyright violations. If access to this protected content on the digital storage medium 114 is not secure, the content can be quite vulnerable to wide spread distribution. This wide spread distribution can occur by simply copying the digital media files from the digital storage medium 114 or physically removing the digital storage medium from the multimedia device 102. To facilitate protection of the media content provider, the digital media content can be secured before it is stored on the digital storage medium. The present invention enables digital media content to be easily stored in the multimedia device. The digital media files may be deleted from the multimedia device, but once the digital media files are stored on the digital storage medium, they cannot be transferred to another device. The inability to transfer the digital media files can allow media content providers to be secure in distributing their multimedia products to the multimedia device in a digital format with minimal fear of copyright violations.

When digital information is stored on a digital storage device the information is typically stored in a specific file format. The specific file format can enable an operating system to know where to “look” to retrieve desired digital information from the digital storage device. For example, the Microsoft Windows® operating system commonly uses a file format referred to as a File Allocation Table (FAT). The FAT is typically stored on a computer's hard disc after the boot-up sector. A single file may be stored in many sections scattered across the hard disc. The FAT is typically used to keep track of where each file is stored on the hard disc.

In the present invention, a predetermined file format can be used to store the digital media content. The predetermined file format can be configured to be incompatible with the file formats used by major computer operating systems, such as Windows, Linux, Unix, and Apple's operating system. The predetermined file format can allow digital media content to be saved on the digital storage medium 114 without allowing easy access to the digital storage medium by external devices controlled by these operating systems. Since the predetermined file format is not compatible with the storage format used by these operating systems, the digital media files stored on the digital storage medium can be substantially secure.

In the following discussion the file format is referred to as the digital storage medium format information. The term “data” is used to refer to digital media files plus digital storage medium format information. A “data stream” refers to one or more digital storage medium commands plus the “data”.

A digital storage security module 110 can be placed between the media bridge 108 and the digital storage medium 114 to provide secure access to the digital media files. The digital storage security module can secure a data stream that includes the digital media files and digital storage medium format information before it is stored on the digital storage medium. Interfacing with the media bridge 108 or media processor 116 can require that transferred data to or from the digital storage medium be preceded by commands. The digital storage medium, being an unsecured device, is not able to process commands that have been secured. The digital storage security module can be configured to monitor the data stream and distinguish commands from data; leaving hardware commands unsecured while securing the data. For example, if the digital storage medium is an ATA hard drive, the digital storage security module can leave the commands necessary to operate the ATA hard drive unsecured. By securing only the data, and not the commands to the digital storage medium, the digital storage security module can enable the digital media files and format information to be securely stored on the digital storage medium without requiring specialized chips to send, receive, and store the secured data.

A variety of methods can be used to implement the digital storage security module. In one embodiment, the data transferred to or from the digital storage medium can be scrambled by the digital storage security module 110. In another embodiment a symmetric key encryption technology can be established in which a key can be assigned to the digital storage security module 110. Data stored on the digital storage medium 114 can be encrypted using a closely held key. The digital security storage module can use the assigned key to decrypt the data stored on the digital storage medium. Without knowledge of the closely held key, the data stored on the digital storage medium is encrypted and cannot be used.

The secured digital media content on the digital storage medium 114 can be unsecured before sending the content to the media processor 116. The content can be unsecured by sending it through the digital storage security module 110. The unsecured digital media content can then be sent to the media processor 116. In another embodiment, the media processor can be configured to also act as the digital storage security module. This can enable the multimedia device 102 to be more secure, as the secured digital media content can be sent directly to the media processor without first being unsecured. Thus, the unsecured digital media content cannot be intercepted between the digital storage security module chip and the media processor.

Securing the digital storage medium data before it is stored in the digital storage medium 114 can help to assure the digital media content provider that the digital media content is secure and cannot be easily accessed to freely transfer the content to other consumers. This assurance can encourage more digital media content providers to allow their products to be transmitted digitally, thus providing a new market for providers to sell their content. Even if the digital storage medium is removed from the multimedia device 102, the digital media content in the digital storage medium is still secured such that the content is made useless to others.

The multimedia device 102 can require that an authentication process be completed by connecting the multimedia device to a locally attached computer 104 or via the internet 107 before access to the digital media content stored on the digital storage medium 114 is granted. The computer or internet connection to the multimedia device can be made via an authentication port 106. The authentication process can enable another layer of security, allowing only an approved multimedia device to receive digital media content from the media source. The authentication process can occur between the computer and the multimedia device or directly between the internet and the multimedia device. The authentication process can occur over a Universal Serial Bus, a Firewire bus, an Ethernet connection, a serial bus, a parallel bus, or another connection that is suitable to participate in a bi-directional exchange of authentication information with the multimedia device. The authentication port can be connected internally to an authentication bridge 112. The authentication bridge can be configured to facilitate the authentication process between the computer or internet and the media processor 116.

When authentication is verified by the media processor 116, access to the digital storage medium 114 can be enabled. If authentication is not received, the multimedia device 102 can disable access to the digital storage medium.

Several methods can be used to implement the authentication process. In one embodiment a public/private key technology can be used in the authentication process. Each time a connection attempt is made to the digital storage medium 114 from the computer 104 or internet 107 a public/private key pair can be generated within the multimedia device 102. Following a public key exchange the multimedia device can authenticate the connecting entity by a decryption process using its private key. If the authentication is not successful, the connection can be terminated and access to the digital storage medium can be denied.

In another embodiment, the authentication process can be reversed, requiring the multimedia device 102 to authenticate itself to a media source. In this embodiment the multimedia device can be connected to the computer 104 or directly to the internet 107. A code, such as the public key describe above, can be transmitted from the multimedia device to the digital media content provider. The digital media content provider can decide whether each file on their site requires an approved authentication code before being downloaded to the multimedia device and stored in the digital storage medium 114.

The digital media content sent from the digital storage medium 114 can be rendered by the media processor 116. For example, an audio or video file may be stored in any popular format such as a .wav, .mp3, .avi, or a .wmv format. The media processor can unsecure, decompress, and process the audio or video file into a digital format ready for output to a digital to analog converter. Unsecuring can involve decrypting or descrambling a digital file to obtain the original digital file as it was prior to being secured. In one embodiment of the present invention, the media processor can process the audio or video file into audio and video streams. The audio and video streams can be converted by a digital to analog converter and sent to speakers and/or a display. The digital to analog converter can either be internal to the media processor, or a separate chip external to the media processor. Alternatively, the media processor can send the processed audio and/or video file to an audio/video compression-decompression (“codec”) chip 118 for conversion from the digital to the analog domain. The output of the codec chip can be sent to speakers and/or a display.

The multimedia device 102 can have a display screen 120 operatively attached to the device. The display screen can be a liquid crystal display (LCD), an organic light emitting display, or another type of display capable of displaying full motion video. Speakers can also be operatively attached to the multimedia device. An audio/video port 122 can be configured to send audio and video to external speakers and displays 124. The audio/video port 122 can include connectors to transmit the audio and video signals. The connectors can be RCA connectors, 6.5 mm jacks, fiber optic connectors, s-type connectors, or any other type of connectors able to transmit an audio or video signal.

To further secure the digital media a real time clock 126 can be connected to the media processor 116 within the multimedia device 102. The multimedia device can be connected to a computer 104 or directly to the internet 107. The time from a real time clock in the computer, or at a predetermined site on the Internet, can be received by the media processor and stored on the multimedia device's digital storage medium 114. An internal clock within the multimedia device can be used to record a local time “T₀” at which the multimedia device is attached to the computer or Internet can be on the digital storage medium. When the multimedia device is disconnected from the computer or Internet a local time “T₁” can be received by the media processor and recorded on the digital storage medium. The media processor can be used to determine the difference between T₁ and T₀ and add the difference to the time received from the computer or Internet. The time plus the difference can be used to set the real time clock in the multimedia device.

Once the real time clock 126 is set it can be used to enable digital media content providers to provide media for a predetermined amount of time. The media processor can be configured to disable specific media content stored on the digital storage medium according to the predetermined amount of time. For example, a media content provider may allow a song to be downloaded for one week. One week after the song has been downloaded the media processor can either disable the song from being played, or optionally delete the song from the digital storage medium. In another embodiment, a media content provider can allow a media file to be downloaded and played a predetermined number of times. The media content provider may allow a media file to be downloaded and played for a predetermined time or for a set number of times when a proper authentication code is not received from the multimedia device. If a proper authentication code is received, the media file may be allowed to be played for a longer duration, or even indefinitely.

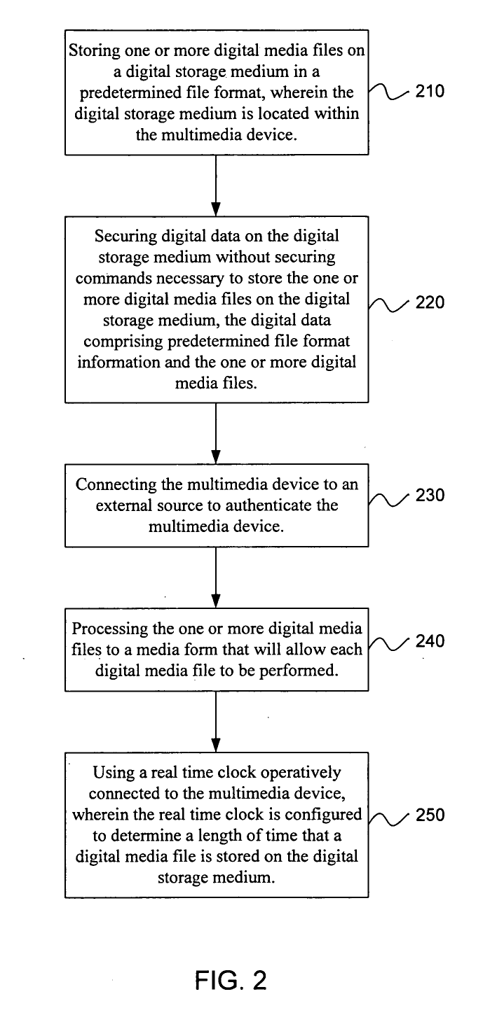

Another aspect of the invention provides a method for securely distributing digital media content to a multimedia device, as depicted in the flow chart of FIG. 2. The method can include the operation of storing one or more digital media files on a digital storage medium in a predetermined file format, wherein the digital storage medium is located within the multimedia device, as shown in block 210. The digital media can be transmitted to the multimedia device from a computer, a computer connected to the internet, or directly from the internet. The predetermined file format can be configured to be inoperable with common file formats available on home and business computers. The method can further include the operation of securing digital data on the digital storage medium without securing commands necessary to store the one or more digital media files on the digital storage medium, the digital data comprising predetermined file format information and the one or more digital media files, as shown in block 220. The digital storage medium can be a hard drive, an optical drive, or solid state memory such as RAM, MRAM, Flash RAM, and other forms of memory capable of storing large multimedia files. The digital media can be secured before being stored on the digital storage medium. The digital media can be secured by a digital storage security module. The digital storage security module can leave hardware commands for the digital storage medium unsecured.

A further operation can involve connecting the multimedia device to an external source to authenticate the multimedia device, as shown in block 230. As previously discussed, an authentication process can occur between a computer and the multimedia device or directly between the Internet and the multimedia device. Authentication can be used to disable the multimedia device itself, or specific media files located on the multimedia device. Media content providers may also require authentication of the multimedia device before allowing its media content to be stored on the multimedia device.

Another operation can involve processing the one or more digital media files to a media form that will allow each digital media file to be performed, as shown in block 240. An additional operation can be using a real time clock operatively connected to the multimedia device, wherein the real time clock is configured to determine a length of time that a digital media file is stored on the digital storage medium, as shown in block 250. Media content providers can allow their media files to be stored on the multimedia device and performed for a predetermined amount of time. The real time clock can enable the media files to be disabled so that they are no longer able to be performed on the multimedia device. Alternatively, media files which have been stored in the multimedia device longer than the predetermined amount of time can be deleted from the digital storage medium.

The present invention comprises multiple levels of security which enable digital media content to be securely transferred from a media content provider to a multimedia device. The digital media content can be securely stored within the multimedia device on a digital storage medium in a secured format. The secured format can include both encryption, scrambling, and the use of a predetermined storage format. An authentication code can be required before digital media can be downloaded to the multimedia device and/or removed from the device. A real time clock within the multimedia device can enable a media content provider to allow the digital media content to be performed in the multimedia device for a predetermined amount of time. The multiple levels of security provided by the multimedia device can create a synergistic effect, enabling a media content provider to set a desired level of security for their media files before the files can be stored on the multimedia device. The security can enable media content providers to distribute digital media content with minimal concern for violation of the media content provider's copyrights. This security can enable new opportunities to open, allowing convenience for customers and new markets for multimedia companies.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments of the invention. It will be apparent to those of ordinary skill in the art that numerous modifications can be made without departing from the principles and concepts of the invention as set forth in the examples.

What is claimed is:

1. A digital media storage system for securely storing and performing digital media files, the system comprising:
a multimedia device having a digital storage medium, wherein the digital storage medium is configured to store one or more digital media files according to a predetermined storage format;
a digital storage security module operatively coupled to the digital storage medium and configured to secure data prior to the data being stored on the digital storage medium, the data comprising the one or more digital media files and format information from the predetermined storage format, the digital storage security module further configured to leave hardware commands unsecured;
a media processor operatively coupled to the digital storage security module and configured to unsecure each of the one or more digital media files and convert each of the one or more digital media files to a format able to be performed; and
one or more input/output structures in communication with the media processor, the one or more input/output structures configured to send and receive data.

2. A digital media storage system as in claim 1, wherein the predetermined storage format comprises a storage format configured to store the one or more digital media files on the digital storage medium in a proprietary manner.

3. A digital media storage system as in claim 1, further comprising a viewing screen coupled to the multimedia device and in communication with the media processor and configured to display the one or more digital media files stored on the digital storage medium.

4. A digital media storage system as in claim 1, wherein the media processor is configured to convert the one or more digital media files to an analog video stream.

5. A digital media storage system as in claim 1, wherein the media processor is configured to convert the one or more digital media files to a digital video stream.

6. A digital media storage system as in claim 1, wherein the media processor is configured to convert the one or more digital media files to an analog audio stream.

7. A digital media storage system as in claim 1, wherein the media processor is configured to convert the one or more digital media files to a digital audio stream.

8. A digital media storage system as in claim 1, further comprising a real time clock operatively connected to the media processor, the real time clock configured to enable the media processor to disable specific digital media files stored on the digital storage medium after a predetermined amount of time.

9. A digital media storage system as in claim 1, wherein the one or more input/output structures includes an authentication port configured to enable authentication of the multimedia device with a computer or internet server.

10. A digital media storage system as in claim 9, further comprising an encryption algorithm in which a public and private key pair is generated by the digital storage security module and the public key is exchanged with the computer or internet server to authenticate the multimedia device.

11. A digital media storage system as in claim 9, wherein the authentication port comprises a connector selected from a connector from the group consisting of a Universal Serial Bus connector, an Ethernet connector, a Firewire bus connector, a serial bus connector, and a parallel bus connector.

12. A digital media storage system as in claim 1, wherein the digital storage medium is selected from the group consisting of a hard drive, an optical disk, and solid state memory.

13. A digital media storage system for securely storing and performing digital media files, the system comprising:
a multimedia device having a digital storage medium, wherein the digital storage medium is configured to store one or more digital media files according to a predetermined storage format;
a digital storage security module operatively coupled to the digital storage medium and configured to secure data prior to the data being stored on the digital storage medium, the data comprising the one or more digital media files and format information from the predetermined storage format, the digital storage security module further configured to leave hardware commands unsecured;
a media processor operatively coupled to the digital storage security module and configured to unsecure the one or more digital media files and convert the one or more digital media files to a format which can be performed;
an authentication port in communication with the media processor and configured to enable a connection between a computer or an Internet server and the media processor, wherein authentication of the multimedia device is verified by the media processor to allow access to the one or more digital media files stored on the digital storage medium; and
a real time clock operatively connected to the media processor and configured to enable the media processor to disable access to specific digital media files after the specific digital media files has been stored in the digital storage medium for a predetermined amount of time.

14. A digital media storage system as in claim 13, wherein one or more specific digital media files are deleted from the digital storage medium after the predetermined amount of time has passed.

15. A method for securely storing and performing digital media files in a multimedia device, comprising the steps of:
storing one or more digital media files on a digital storage medium in a predetermined file format, wherein the digital storage medium is located within the multimedia device;
securing digital data on the digital storage medium without securing commands necessary to store the one or more digital media files on the digital storage medium, the digital data comprising predetermined file format information and the one or more digital media files;
connecting the multimedia device to an external source to authenticate the multimedia device;
processing the one or more digital media files to a media form that will allow each digital media file to be performed; and
using a real time clock operatively connected to the multimedia device, wherein the real time clock is configured to determine a length of time that a digital media file is stored on the digital storage medium.

16. A method as in claim 15, further comprising the step of transmitting digital media to the multimedia device.

17. A method as in claim 16, wherein transmitting digital media further comprises transmitting encrypted digital media to the multimedia device.

18. A method as in claim 16, wherein transmitting digital media further comprises transmitting unencrypted digital media to the multimedia device.

19. A method as in claim 15, wherein securing digital data includes encrypting the digital data on the digital storage medium.

20. A method as in claim 15, wherein securing digital data includes scrambling the digital data on the digital storage medium.

21. A method as in claim 16, wherein transmitting digital media further comprises transmitting digital media from a computer to the multimedia device.

22. A method as in claim 21, further comprising transmitting digital media from a computer connected to the Internet to the multimedia device.

23. A method as in claim 16, wherein transmitting digital media further comprises transmitting digital media from the Internet to the multimedia device.

24. A method as in claim 15, wherein the step of connecting the multimedia device to an external source to authenticate the multimedia device further comprises the step of connecting the multimedia device to an external source to authenticate the multimedia device prior to transmitting the one or more digital media files to the multimedia device.

25. A method as in claim 15, wherein the step of connecting the multimedia device to an external source to authenticate the multimedia device further comprises the step of connecting the multimedia device to an external source to authenticate the multimedia device prior to enabling the multimedia device to access the digital storage medium.

26. A method as in claim 15, wherein the step of using a real time clock further comprising the step of using a real time clock operatively connected to the multimedia device, wherein the media processor is configured to disable access to specific digital media files after they have been stored on the digital storage medium for a predetermined amount of time.

27. A method as in claim 15, wherein the step of using a real time clock further comprising the step of using a real time clock operatively connected to the multimedia device, wherein the media processor is configured to delete specific digital media files from the digital storage medium after they have been stored on the digital storage medium for a predetermined amount of time.

28. A method as in claim 15, wherein processing the digital media files further comprises unsecuring, decompressing, and processing the one or more digital media files into an audio stream.

29. A method as in claim 28, further comprising processing the one or more digital media files into an analog audio stream.

30. A method as in claim 28, further comprising processing the one or more digital media files into a digital audio stream.

31. A method as in claim 15, wherein processing the digital media files further comprises unsecuring, decompressing, and processing the one or more digital media files into a video stream.

32. A method as in claim 31, further comprising processing the one or more digital media files into a digital video stream.

33. A method as in claim 31, further comprising processing the one or more digital media files into an analog video stream.

34. A system for securely storing and performing digital media files in a multimedia device, comprising:
a storing means for storing one or more digital media files on a digital storage medium in a predetermined file format, wherein the digital storage medium is located within the multimedia device;
a securing means for securing the one or more digital media files on the digital storage medium without securing commands necessary to store the one or more digital media files on the digital storage medium;
an authentication means for authenticating the multimedia device;
a processing means for unsecuring the one or more digital media files and converting the one or more digital media files to a form able to be performed; and
a timing means for determining how long specific digital media files are stored on the digital storage medium.
